(19) United States
(12) Patent Application Publication
(10) Pub. No.: US 2025/0013183 A1
(43) Pub. Date: Jan. 9, 2025

(54) IMAGE FORMING APPARATUS AND PROCESS CARTRIDGE

(71) Applicant: FUJIFILM Business Innovation Corp., Tokyo (JP)

(72) Inventor: Minoru ROKUTAN, Kanagawa (JP)

(73) Assignee: FUJIFILM Business Innovation Corp., Tokyo (JP)

(21) Appl. No.: 18/429,443

(22) Filed: Feb. 1, 2024

(30) Foreign Application Priority Data
Jul. 7, 2023 (JP) 2023-112614

(51) Int. Cl. G03G 21/00

(52) U.S. Cl. CPC G03G 21/0017; G03G 2221/0005

(57) ABSTRACT

An image forming apparatus includes a member to be cleaned, and a cleaning blade that is brought into contact with the member to be cleaned and cleans the member to be cleaned and that is provided with both end portions in a longitudinal direction protruding from the member to be cleaned.

### CROSS-REFERENCE TO RELATED APPLICATIONS

This application is based on and claims priority under 35 USC 119 from Japanese Patent Application No. 2023-112614 filed Jul. 7, 2023.

### BACKGROUND

### (i) Technical Field

The present invention relates to an image forming apparatus and a process cartridge.

### (ii) Related Art

In the related art, in an image forming apparatus adopting an electrophotographic method, such as a copy machine, a printer, or a facsimile machine, a cleaning blade is used as a cleaning unit for removing deposits such as residual toner on the surface of a member to be cleaned, such as an image holder (a photoreceptor or the like), a charging member (a charging roll or the like), a transfer member (an intermediate transfer belt, a secondary transfer roll, or the like), a fixing member (a heating belt, a pressure roll, or the like), a transporting member (a transport belt, or the like) has been used.

For example, in JP2003-186335A, “A fixing device including a heating member and a pressure member that heat and pressurize a toner image formed on a recording material to fix the toner image on the recording material, a cleaning roller that cleans toner adhering to the surface of at least one member of these members, and a cleaning blade for scraping off toner accumulated on a surface of the cleaning roller, in which the cleaning blade includes a backing blade that supports the cleaning blade, and the cleaning blade is provided longer than a backing blade in an abutting direction with a cleaning roller.” is disclosed.

In addition, in JP5754896B, “An image forming apparatus including a cleaning blade, a member to be cleaned which is movable and from which toner adhering on a surface is removed by the cleaning blade, and L-shaped end portion members which are disposed on both end portion sides in a longitudinal direction of the cleaning blade, the end member covering an end portion and an overlapping region where the end portion member overlaps the cleaning blade when the cleaning blade is viewed from a movement direction of the cleaning blade, in which in the member to be cleaned, in a case where an end of the overlapping region on the center side in the longitudinal direction is defined as boundary line, a surface roughness of a region on the end side of the boundary line in the longitudinal direction is smoother than the surface roughness of a region on the center side of the boundary line in the longitudinal direction.” is disclosed.

### SUMMARY

Aspects of non-limiting embodiments of the present disclosure relate to an image forming apparatus that includes a cleaning blade being brought into contact with a member to be cleaned and cleaning the member to be cleaned, in which as compared with a case of including a cleaning blade that is provided with both end portions in a longitudinal direction not protruding from the member to be cleaned, curling of the cleaning blade is suppressed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Means for addressing the above problems include the following aspect.

According to an aspect of the present disclosure, there is provided an image forming apparatus including, a member to be cleaned, and a cleaning blade that is brought into contact with the member to be cleaned and cleans the member to be cleaned and that is provided with both end portions in a longitudinal direction protruding from the member to be cleaned.

### BRIEF DESCRIPTION OF THE DRAWINGS

Exemplary embodiment(s) of the present invention will be described in detail based on the following figures, wherein:

FIG. 1 is a schematic view illustrating an installation condition of a cleaning blade to a member to be cleaned in the present exemplary embodiment;

FIG. 2 is a schematic view illustrating an installation condition of a cleaning blade to a member to be cleaned in the present exemplary embodiment; and

FIG. 3 is a schematic view showing an example of an image forming apparatus according to the present exemplary embodiment.

### DETAILED DESCRIPTION

Hereinafter, exemplary embodiments that are examples of the present invention will be described.

Hereinafter, the present exemplary embodiment as an example of the present invention will be described. The description and examples of these exemplary embodiments illustrate the exemplary embodiments and do not limit the scopes of the exemplary embodiments.

Regarding the ranges of numerical values described in stages in the present exemplary embodiment, the upper limit value or lower limit value of a range of numerical values may be replaced with the upper limit or lower limit of another range of numerical values described in stages. In addition, regarding the ranges of numerical values described in the present exemplary embodiment, the upper limit value or lower limit value of a range of numerical values may be replaced with values described in examples.

In the present exemplary embodiment, the term “step” includes not only an independent step but also a step that cannot be clearly distinguished from other steps but can achieve the expected object thereof.

In the present exemplary embodiment, in a case where an exemplary embodiment is described with reference to drawings, the configuration of the exemplary embodiment is not limited to the configuration shown in the drawings. In addition, the sizes of members in each drawing are conceptual, and a relative relationship between the sizes of the members is not limited thereto.

In the present exemplary embodiment, each component may include two or more kinds of corresponding substances. In a case where the amount of each component in a composition is mentioned in the present exemplary embodiment, and there are two or more kinds of substances corresponding to each component in the composition, unless otherwise specified, the amount of each component means the total amount of two or more kinds of the substances present in the composition.

### Image Forming Apparatus

The image forming apparatus according to the present exemplary embodiment includes
a member to be cleaned, and
a cleaning blade that is brought into contact with the member to be cleaned and cleans the member to be cleaned and that is provided with both end portions in a longitudinal direction protruding from the member to be cleaned (hereinafter, also referred to as a “blade”).

Here, in the related art, when a cleaning blade is used to clean a member to be cleaned, the curling of the cleaning blade may be occurred (hereinafter, also referred to as “blade curling”). In particular, in a case where the line contact pressure of the blade to the member to be cleaned and the contact angle of the blade to the member to be cleaned are increased for the purpose of improving the cleaning properties, the blade curling is likely to be occurred.

Blade curling is likely to occur at both end portions in the longitudinal direction of the blade. In a case where the blade is provided not to protrude from the member to be cleaned, the line contact pressure at both end portions in the longitudinal direction of the blade is lower than the central portion in the longitudinal direction of the blade with respect to the member to be cleaned. Therefore, the blade curling tends to occur at both end portions in the longitudinal direction of the blade.

Therefore, in the image forming apparatus according to the present exemplary embodiment, the cleaning blade is provided to protrude from the member to be cleaned. Then, even at both end portions of the blade in the longitudinal direction, the blade is in contact with the member to be cleaned with a sufficient line contact pressure. Thereby, the blade curling is suppressed.

As described above, in the image forming apparatus according to the present exemplary embodiment, the blade curling is suppressed by the above configuration.

Hereinafter, details of the image forming apparatus according to the present exemplary embodiment will be described.

### Aspects of Arrangement of Cleaning Blade to Member to be Cleaned

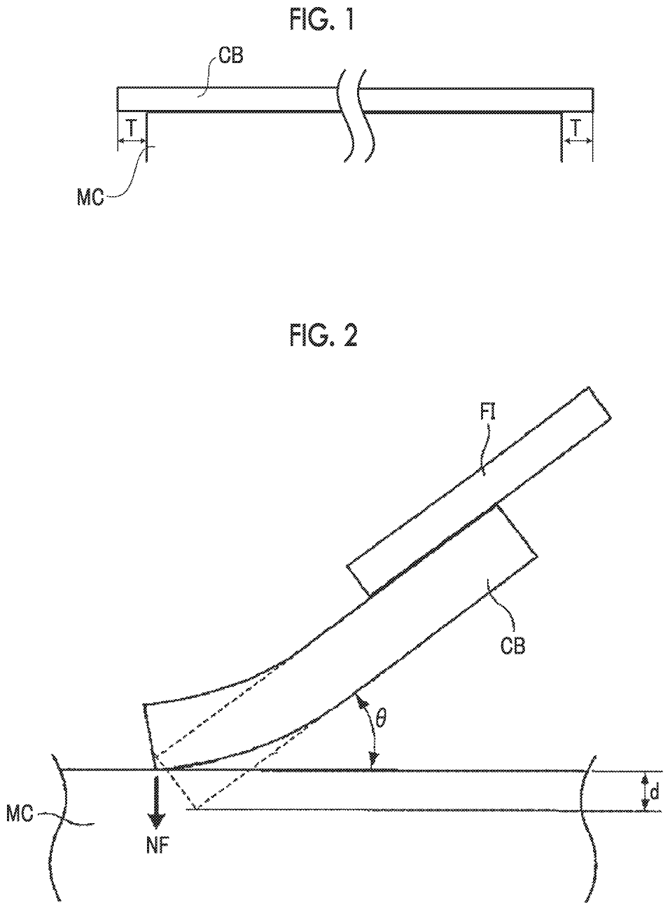

The cleaning blade is provided with both end portions in the longitudinal direction of the blade to protrude from the member to be cleaned (see FIG. 1).

Specifically, for example, in a state where the blade is provided along the axial direction or the width direction of the member to be cleaned, both end portions in the longitudinal direction of the blade protrude from both end portions in the axial direction or both end portions in the width direction of the member to be cleaned, respectively. The blade may be provided with the longitudinal direction of the blade inclined in the axial direction or the width direction of the member to be cleaned.

The protrusion length at an end portion in the longitudinal direction of the cleaning blade from the member to be cleaned is, for example, preferably 0.1 mm or more, more preferably 0.5 mm or more, and even more preferably 1.0 mm or more.

In a case where the protrusion amount of the end portions in the longitudinal direction of the blade is in the above range, even at both end portions of the blade in the longitudinal direction, the blade is likely to be in contact with the member to be cleaned with a more sufficient line contact pressure. Thereby, the blade curling is easily suppressed.

From the viewpoint of reducing the installation space of the blade, for example, the protrusion length of the end portion in the longitudinal direction of the blade is preferably 10 mm or less.

Here, the “protrusion length of the end portion in the longitudinal direction of the blade” is a length along the longitudinal direction of the blade, and means a length from the edge of an end portion in the axial direction or the width direction of the member to be cleaned to the edge of the end portion in the longitudinal direction of the blade (see T in FIG. 1).

In FIG. 1, CB represents a cleaning blade, MC represents a member to be cleaned, and T represents a protrusion length at an end portion in the longitudinal direction of the blade.

The line contact pressure of the cleaning blade to the member to be cleaned is, for example, preferably 1.5 gf/mm or more and 4.0 gf/mm or less and more preferably 1.7 gf/mm or more and 3.0 gf/mm or less.

In a case where the line contact pressure of the blade is in the above range, the cleaning properties are improved. That is, the blade curling is suppressed while sufficiently ensuring the cleaning properties.

The contact angle of the cleaning blade to the member to be cleaned is, for example, preferably 180 or more and 50° or less and more preferably 20° or more and 40° or less.

In a case where the contact angle of the blade is in the above range, the cleaning properties are improved. That is, the blade curling is suppressed while sufficiently ensuring the cleaning properties.

Here, the line contact pressure NF of the blade is calculated by the following formula.

NF=k×d Formula:

In the expression, k represents a spring constant unique to the cleaning blade, and d represents an intrusion of the cleaning blade into the member to be cleaned (see FIG. 2).

The spring constant k unique to the cleaning blade is obtained by causing displacement of the cleaning blade and measuring the load with a load cell.

The intrusion d of the cleaning blade into the member to be cleaned is determined by calculating the amount of displacement of the member to be cleaned caused in a case where the cleaning blade fixed to the fixture is brought into contact with the member to be cleaned.

In addition, the contact angle of the blade means an angle (sharp angle θ) at which, in a state where the blade is in contact with the member to be cleaned, an imaginary line along the non-bent portion of the ventral surface of the blade and a tangent line at a point where the imaginary line comes into contact with the surface of the member to be cleaned intersect (see FIG. 2).

In FIG. 2, CB represents the cleaning blade, MC represents the member to be cleaned, FI represents the fixture, NF represents the line contact pressure of the cleaning blade, d represents an intrusion of the cleaning blade into the member to be cleaned, and θ represents the contact angle of the cleaning blade.

### Member to be Cleaned

The member to be cleaned is a target member to be cleaned by the cleaning blade.

Examples of the member to be cleaned include an image holder (a photoreceptor and the like), a charging member (a charging roll and the like), a transfer member (an intermediate transfer belt, a secondary transfer roll, and the like), a fixing member (a heating belt, a pressure roll, and the like), a transporting member (a transport belt and the like), and the like.

### Cleaning Blade

### Layer Configuration

The cleaning blade may be configured, for example, with a single layer, two layers, or three or more layers, or may have other configurations.

Examples of the cleaning blade configured with a single layer include a cleaning blade configured entirely of a single contact member including a contact portion that is brought into contact with the member to be cleaned.

Examples of the cleaning blade configured with two layers include a cleaning blade provided with a first layer that consists of a contact member including a contact portion that is brought into contact with a member to be cleaned and a second layer (also called a non-contact member) as a back surface layer that is formed on the back surface side of the first layer and consists of a material different from the contact member.

Examples of the cleaning blade configured with three or more layers include a cleaning blade having another layer (this layer is also called a non-contact portion) between the first layer and the second layer in the aforementioned cleaning blade configured with two layers.

The cleaning blade is fixedly supported by, for example, a rigid plate-shaped fixture.

### Contact Member

The contact member is a member including a contact portion that is brought into contact with the member to be cleaned.

The contact member (that is, the contact portion) is configured with, for example, a rubber elastic member. Examples of the rubber elastic member include polyurethane rubber, polyimide rubber, silicone rubber, fluororubber, propylene rubber, and butadiene rubber. However, from the viewpoint of excellent wear resistance and excellent mechanical strength, the rubber elastic member preferably contains, for example, polyurethane rubber.

The polyurethane rubber can be obtained by polymerizing at least a polyol component and a polyisocyanate component. As necessary, the polyurethane rubber may be obtained by polymerizing a resin having a functional group capable of reacting with an isocyanate group in the polyisocyanate component, in addition to the polyol component.

The polyurethane rubber configuring the contact portion includes hard segments and soft segments. In the polyurethane rubber, “hard segment” means a segment that consists of a material relatively harder than a material configuring “soft segment”, and “soft segment” means a segment that consists of a material relatively softer than the material configuring “hard segment”.

Examples of the material configuring the hard segment (hard segment material) include a low-molecular-weight polyol among polyol components, a resin having a functional group capable of reacting with an isocyanate group in the polyisocyanate component, and the like. On the other hand, examples of the material configuring the soft segment (soft segment material) include a high-molecular-weight polyol among polyol components.

### Polyol Component

The polyol component contains a high-molecular-weight polyol and a low-molecular-weight polyol.

The high-molecular-weight polyol is a polyol having a number-average molecular weight of 500 or more (for example, preferably 500 or more and 5,000 or less).

Examples of the high-molecular-weight polyol include known polyols such as a polyester polyol obtained by dehydration condensation of a low-molecular-weight polyol and a dibasic acid, a polycarbonate polyol obtained by a reaction between a low-molecular-weight polyol and an alkyl carbonate, a polycaprolactone polyol, and a polyether polyol.

Examples of commercially available products of high-molecular-weight polyols include PLACCEL 205 PLACCEL 240 manufactured by Daicel Corporation, and the like.

Here, the number-average molecular weight is a value measured by a gel permeation chromatography (GPC) method. The same applies hereinafter.

One high-molecular-weight polyol may be used alone, or two or more high-molecular-weight polyols may be used in combination.

The polymerization ratio of the high-molecular-weight polyol to all the polymerization components of the polyurethane rubber may be, for example, 30 mol % or more and 50 mol % or less, and is preferably 40 mol % or more and 50 mol % or less.

The low-molecular-weight polyol is a polyol having a molecular weight (or a number-average molecular weight) of less than 500. The low-molecular-weight polyol is also a material that functions as a chain extender and a crosslinking agent.

Examples of the low-molecular-weight polyol include 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanedecanediol. Among these, for example, 1,4-butanediol is preferably employed as the low-molecular-weight polyol.

Examples of the low-molecular-weight polyol also include polyols such as a diol (difunctional), a triol (trifunctional), and a tetraol (tetrafunctional) which are known as chain extenders and crosslinking agents.

One low-molecular-weight polyol may be used alone, or two or more low-molecular-weight polyols may be used in combination.

The polymerization ratio of the low-molecular-weight polyol to all the polymerization components of the polyurethane rubber may be, for example, more than 50 mol % and 75 mol % or less, preferably 52 mol % or more and 75 mol % or less, more preferably 55 mol % or more and 75 mol % or less, and even more preferably 55 mol % or more and 60 mol % or less.

### Polyisocyanate Component

Examples of the polyisocyanate component include 4,4′-diphenylmethane diisocyanate (MDI), 2,6-toluene diisocyanate (TDI), 1,6-hexane diisocyanate (HDI), 1,5-naphthalene diisocyanate (NDI), and 3,3′-dimethylbiphenyl-4,4′-diisocyanate (TODI). Among these, as the polyisocyanate component, for example, 4,4′-diphenylmethane diisocyanate (MDI), 1,5-naphthalene diisocyanate (NDI), and hexamethylene diisocyanate (HDI) are more preferable.

One polyisocyanate component may be used alone, or two or more polyisocyanate components may be used in combination.

The polymerization ratio of the polyisocyanate component to all the polymerization components of the polyurethane rubber may be, for example, 5 mol % or more and 25 mol % or less, and preferably 10 mol % or more and 20 mol % or less.

Resin Having Functional Group Capable of Reacting with Isocyanate Group

As the resin having a functional group capable of reacting with an isocyanate group (hereinafter, also called “reactive group-containing resin”), for example, a flexible resin is preferable, and an aliphatic resin having a linear structure is more preferable in view of flexibility. Specific examples of the reactive group-containing resin include an acrylic resin containing two or more hydroxyl groups, a polybutadiene resin containing two or more hydroxyl groups, an epoxy resin having two or more epoxy groups, and the like.

Examples of commercially available products of acrylic resins containing two or more hydroxyl groups include ACTFLOW manufactured by Soken Chemical & Engineering Co., Ltd. (grades: UMB-2005B, UMB-2005P, UMB-2005, UME-2005, and the like).

Examples of commercially available products of the polybutadiene resin containing two or more hydroxyl groups include R-45HT manufactured by Idemitsu Kosan Co., Ltd.

As the epoxy resin having two or more epoxy groups, for example, an epoxy resin is desirable which is not hard and brittle just as the general epoxy resins of the related art and is more flexible and tougher than the epoxy resin of the related art. As such an epoxy resin, for example, in view of molecular structure, an epoxy resin is preferable which has a structure (also called a flexible skeleton) capable of improving mobility of the main chain in the main chain structure of the epoxy resin. Examples of the flexible skeleton include an alkylene skeleton, a cycloalkane skeleton, and a polyoxyalkylene skeleton. Among these, for example, a polyoxyalkylene skeleton is particularly preferable.

In addition, in terms of the physical properties, compared to the epoxy resin of the related art, for example, an epoxy resin having a low viscosity relative to the molecular weight is preferable. Specifically, for example, the weight-average molecular weight is in a range of 900±100 and the viscosity at 25° C. is desirably in a range of 15,000±5,000 mPa s and more desirably in a range of 15,000±3,000 mPa s. Examples of commercially available products of epoxy resins having such characteristics include EPICLON EXA-4850-150 manufactured by DIC Corporation.

One reactive group-containing resin may be used alone, or two or more reactive group-containing resins may be used in combination.

### Manufacturing Method of Polyurethane Rubber

The polyurethane rubber may be manufactured using raw materials for manufacturing polyurethane rubber including the polyol component and polyisocyanate component described above and, as necessary, a resin having a functional group capable of reacting with a reactive isocyanate group, by a general manufacturing method of polyurethane such as a prepolymer method or a one-shot method. With the prepolymer method, polyurethane rubber having excellent abrasion resistance and excellent chipping resistance is obtained. Therefore, this method is suited for the present exemplary embodiment, but the present exemplary embodiment is not limited by the manufacturing method.

For manufacturing the polyurethane rubber, for example, a catalyst is preferably used.

Examples of catalysts used for manufacturing the polyurethane rubber include an amine-based compound such as a tertiary amine, a quaternary ammonium salt, and an organometallic compound such as an organotin compound.

Examples of the tertiary amine include trialkylamine such as triethylamine, tetraalkyl diamine such as N,N,N′,N′-tetramethyl-1,3-butanediamine, aminoalcohol such as dimethylethanolamine, esteramine such as ethoxylated amine, ethoxylated diamine, or bis(diethylethanolamine)adipate, a cyclohexylamine derivative such as triethylenediamine (TEDA) or N,N-dimethylcyclohexylamine, a morpholine derivative such as N-methylmorpholine or N-(2-hydroxypropyl)-dimethylmorpholine, and a piperazine derivative such as N,N′-diethyl-2-methylpiperazine or N,N′-bis-(2-hydroxypropyl)-2-methylpiperazine.

Examples of the quaternary ammonium salt include 2-hydroxypropyltrimethylammonium octylate, 1,5-diazabicyclo[4.3.0]nonen-5 (DBN) octylate, 1,8-diazabicyclo[5.4.0]undec-7 (DBU)-octylate, DBU-oleate, DBU-p-toluenesulfonate, DBU-formate, and 2-hydroxypropyltrimethylammonium formate.

Examples of the organic tin compound include a dialkyltin compound such as dibutyltin dilaurate or dibutyltin di(2-ethylhexoate), stannous 2-ethylcaproate, and stannous oleate.

Among these catalysts, in view of hydrolysis resistance, triethylenediamine (TEDA), which is a tertiary ammonium salt, is used. Furthermore, in view of processability, a quaternary ammonium salt is used. Among the quaternary ammonium salts, 1,5-diazabicyclo[4.3.0]nonen-5 (DBN) octylate, 1,8-diazabicyclo[5.4.0]undec-7 (DBU)-octylate, or DBU-formate with high reaction activity is used.

One catalyst may be used alone, or two or more of catalysts may be used in combination.

The content of the catalyst with respect to the total mass of the polyurethane rubber is, for example, preferably in a range of 0.0005% by mass or more and 0.03% by mass or less, and particularly preferably 0.001% by mass or more and 0.01% by mass or less.

### Impregnated Cured Layer

The polyurethane rubber configuring the contact portion may have, as a surface layer, an impregnated cured layer of an isocyanate compound.

The impregnated cured layer enhances the hardness of the contact portion, and abrasion resistance and chipping resistance can be further improved.

The surface layer of the polyurethane rubber configuring the contact portion means a region at a depth of 200 μm from the surface of the contact portion.

The impregnated cured layer is obtained by modifying the polyurethane rubber configuring the contact portion.

Specifically, the impregnated cured layer is a layer obtained by impregnating the surface layer of the contact portion configured with the polyurethane rubber with a surface treatment liquid containing an isocyanate compound and an organic solvent, and curing the surface treatment liquid (that is, the isocyanate compound) with which the surface layer is impregnated.

The impregnated cured layer is formed as a layer integrated with the surface layer of the contact portion such that the density of the layer gradually decreases toward the inside from the surface.

Examples of the isocyanate compound include 2,6-tolylene diisocyanate (TDI), 4,4′-diphenylmethane diisocyanate (MDI), paraphenylenediisocyanate (PPDI), 1,5-naphthalene diisocyanate (NDI), 3,3′-dimethylbiphenyl-4,4′-diisocyanate (TODI), and multimers and modification products of these.

The surface layer of the polyurethane rubber configuring the contact portion may have a layer impregnated with diamond-like carbon. In addition, a diamond-like carbon layer may be provided on the surface of the polyurethane rubber configuring the contact portion.

Specifically, the layer impregnated with diamond-like carbon or the diamond-like carbon layer (hereinafter, both layers are also referred to as “Tac-treated layers”) is a layer containing tetrahedral amorphous carbon or tetrahedral amorphous carbon.

As the composition of the layer, a layer coated with a known tetrahedral amorphous carbon is used without particular limitation.

In the Tac-treated layer, the ratio of carbon having sp³ hybrid orbital to total carbon, that is, the ratio of carbon having sp³ hybrid orbital to the total of carbon having sp³ hybrid orbital and carbon having sp² hybrid orbital is, for example, preferably 10% or more and 60% or less and more preferably 20% or more and 50% or less.

The ratio of carbon having the sp³ hybrid orbital can be measured by, for example, X-ray photoelectron spectroscopy (XPS) or the like.

As a forming method of the Tac-treated layer, various vapor deposition methods (PVD: physical vapor deposition, CVD: chemical vapor deposition), which are general methods for forming a treated film of tetrahedral amorphous carbon on the surface to be formed.

In a case where a filtered cathodic vacuum arc (FCVA) vapor deposition method, which is an ion beam vapor deposition method using an arc plasma source, is applied as the vapor deposition method, for example, the film formation temperature is preferably 0° C. or higher and 80° C. or lower (for example, more preferably 20° C. or higher and 80° C. or lower and particularly preferably 40° C. or higher and 80° C. or lower), and the film forming rate is preferably 1.5 nm/s.

### Physical Properties of Contact Portion

The Young's modulus of the contact portion is, for example, preferably 5 MPa or more and 30 MPa or less.

Specifically, from the viewpoint of improving the curling of the cleaning blade, the Young's modulus of the contact portion is, for example, preferably 5 MPa or more and more preferably 10 MPa or more. In addition, from the viewpoint of suppressing back surface contamination due to the chipping of the contact portion, the Young's modulus of the contact portion is, for example, preferably 30 MPa or less and more preferably 20 MPa or less.

The Young's modulus is measured as follows.

The Young's modulus is measured using a nanoindentation method. Specifically, by using PICODENTOR HM500 manufactured by Fischer Instrumentation and a Berkovich diamond indenter, an indentation depth-loading curve is drawn. Then, an unloading curve is drawn by applying load so that the maximum indentation depth reaches 1,000 nm and then removing the load, and the slope of the unloading curve is calculated as the Young's modulus.

From the viewpoint of excellent abrasion resistance and excellent chipping resistance, the hardness of the contact portion is, for example, preferably 60 or more and 98 or less, more preferably 65 or more and 97 or less, and even more preferably 70 or more and 95 or less.

The aforementioned hardness is micro rubber hardness. The micro rubber hardness is measured based on the micro hardness MD-1 test method by using a micro rubber hardness tester MD-1 type (polymer A type).

### Molding of Contact Member

The contact member (that is, the contact portion) configured with the polyurethane rubber is prepared by molding a composition for molding a cleaning blade containing the polyurethane rubber or prepolymer in the form of a sheet by using, for example, centrifugal molding, extrusion molding, or the like, and processing the molded resultant by cutting or the like.

The contact member is obtained by molding the composition for molding a cleaning blade. Therefore, the contact member may be configured with the polyurethane rubber as a main component as well as additives used for obtaining the polyurethane rubber, a filler used as necessary, and the like.

### Manufacture of Cleaning Blade

The cleaning blade configured with a single layer is manufactured, for example, by the contact member molding method.

The cleaning blade configured with two layers and the cleaning blade configured with three or more layers are prepared, for example, by bonding a first layer as a contact member and a second layer as a non-contact member (a plurality of layers in a case where the cleaning blade is configured with three or more layers) to each other. As the bonding method, double-sided tape, various adhesives, and the like are used. In addition, during molding, materials of the respective layers may be poured into a mold with variations in time and allowed to be bonded to each other without providing an adhesive layer, such that a plurality of layers stick together.

### Composition of Non-Contact Member

What will be described below is the composition of a non-contact member of a cleaning blade that has a contact member and a non-contact member, such as the aforementioned second layer and other layers, configured with different materials.

Any of known materials can be used for the non-contact member without limitations, as long as the non-contact member has a function of supporting the contact member. Specifically, examples of the material used for the non-contact member include polyurethane rubber, silicon rubber, fluororubber, chloroprene rubber, butadiene rubber, and the like. Among these, for example, polyurethane rubber may be used. Examples of the polyurethane rubber include ester-based polyurethane and ether-based polyurethane. Among these, for example, ester-based polyurethane is particularly desirable.

### Image Forming Apparatus

The image forming apparatus according to the present exemplary embodiment is not particularly limited as long as the image forming apparatus is an image forming apparatus including a member to be cleaned and a cleaning blade.

Specifically, examples of an image forming apparatus according to the present exemplary embodiment include an apparatus including an image holder, a charging device that charges the image holder, an electrostatic latent image forming device that forms an electrostatic latent image on the charged surface of the image holder, a developing device that develops the electrostatic latent image formed on the surface of the image holder with a toner to form a toner image, and a transfer device that transfers the toner image formed on the image holder to a surface of a recording medium.

As the image forming apparatus according to the present exemplary embodiment, known image forming apparatuses are used which include an apparatus including a fixing device that fixes a toner image transferred to the surface of a recording medium; an apparatus including a cleaning device that cleans the surface of an image holder not yet being charged after transfer of a toner image; an apparatus including an electricity removing device that removes electricity by irradiating the surface of an image holder, the image holder not yet being charged, with electricity removing light after transfer of a toner image; an apparatus including an image holder heating member that raises the temperature of an image holder to reduce relative temperature; a transporting device that transports the recording medium; and the like.

Here, as the transfer device, a direct transfer-type apparatus that transfers a toner image formed on a surface of an image holder directly to a recording medium; and an intermediate transfer-type apparatus that performs primary transfer of a toner image formed on a surface of the image holder to a surface of an intermediate transfer member and performs secondary transfer of the toner image transferred to the surface of the intermediate transfer member to a surface of a recording medium are also used.

In a case of the intermediate transfer-type apparatus, the transfer device is, for example, configured to include an intermediate transfer member having a surface onto which the toner image is transferred, a primary transfer device primarily transferring the toner image formed on the surface of the image holder to the surface of the intermediate transfer member, and a secondary transfer device secondarily transferring the toner image transferred to the surface of the intermediate transfer member to the surface of the recording medium.

The image forming apparatus according to the present exemplary embodiment may be any of a dry development type image forming apparatus or a wet development type (development type using a liquid developer) image forming apparatus.

In the image forming apparatus according to the present exemplary embodiment, for example, the portion including the member to be cleaned and the cleaning blade may have a cartridge structure (process cartridge) that is attachable to and detachable from the image forming apparatus.

Hereinafter, an example of the image forming apparatus according to the present exemplary embodiment will be described with reference to drawings. Here, the image forming apparatus according to the present exemplary embodiment is not limited thereto. Further, main parts shown in the figures will be described, but description of other parts will not be provided.

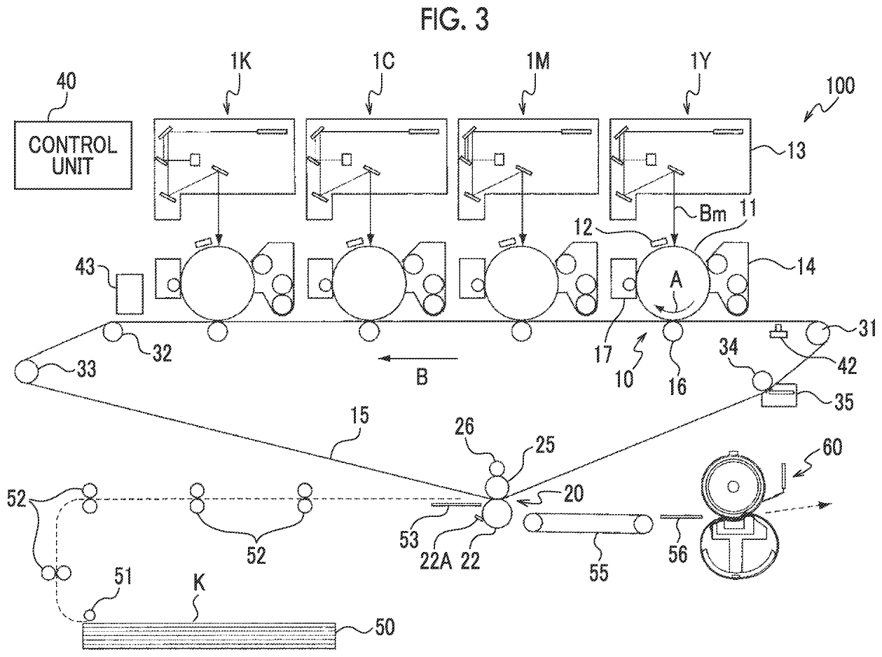

FIG. 3 is a schematic configuration view showing the configuration of the image forming apparatus according to the present exemplary embodiment.

As shown in FIG. 3, an image forming apparatus 100 according to the present exemplary embodiment is, for example, an intermediate transfer-type image forming apparatus that is generally called a tandem type, and includes a plurality of image forming units 1Y, 1M, 1C, and 1K (an example of a toner image forming device) in which a toner image of each color component is formed by an electrophotographic method, a primary transfer portion 10 that performs sequential transfer (primary transfer) of the toner image of each color component formed by each of the image forming units 1Y, 1M, 1C, and 1K to an intermediate transfer belt 15, a secondary transfer portion 20 that performs batch transfer (secondary transfer) of the overlapped toner images transferred to the intermediate transfer belt 15 to paper K as a recording medium, and a fixing device 60 that fixes the images transferred, as secondary transfer, on the paper K. The image forming apparatus 100 also has a control unit 40 that controls the operation of each device (each portion).

Each of the image forming units 1Y, 1M, 1C, and 1K of the image forming apparatus 100 includes a photoreceptor 11 (an example of an image holder) that holds the toner image formed on the surface thereof and rotates in the direction of an arrow A.

Around the photoreceptor 11, there are provided a charger 12 for charging the photoreceptor 11 as an example of a charging device and a laser exposure machine 13 for drawing an electrostatic latent image on the photoreceptor 11 as an example of an electrostatic latent image forming device (in Figure, the exposure beam is represented by a mark Bm).

Around the photoreceptor 11, as an example of a developing device, there are provided a developing machine 14 that contains toners of each color component and makes the electrostatic latent image on the photoreceptor 11 into a visible image by using the toners and a primary transfer roll 16 that transfers toner images of each color component formed on the photoreceptor 11 to the intermediate transfer belt 15 by the primary transfer portion 10.

Around the photoreceptor 11, there are provided a photoreceptor cleaner 17 that removes the residual toner on the photoreceptor 11 and devices for electrophotography, such as the charger 12, the laser exposure machine 13, the developing machine 14, the primary transfer roll 16, and the photoreceptor cleaner 17, that are arranged in sequence along the rotation direction of the photoreceptor 11. These image forming units 1Y, 1M, 1C, and 1K are substantially linearly arranged in order of yellow (Y), magenta (M), cyan (C), and black (K) from the upstream side of the intermediate transfer belt 15.

By various rolls, the intermediate transfer belt 15 is driven to circulate (rotate) in a direction B shown in FIG. 3 at a speed fit for the purpose. As the various rolls, a driving roll 31 that is driven by a motor (not shown in the drawing) excellent in maintaining a constant speed and rotates the intermediate transfer belt 15, a supporting roll 32 that supports the intermediate transfer belt 15 substantially linearly extending along the arrangement direction of the photoreceptors 11, a tension applying roll 33 that applies tension to the intermediate transfer belt 15 and functions as a correcting roll preventing meandering of the intermediate transfer belt 15, a back roll 25 that is provided in the secondary transfer portion 20, and a back roll 34 for cleaning that is provided to face a secondary transfer belt-cleaning blade 35 scrapping off the residual toner or the like on the intermediate transfer belt 15 are provided.

The primary transfer portion 10 is configured with the primary transfer roll 16 that is arranged to face the photoreceptor 11 across the intermediate transfer belt 15. Then, the primary transfer roll 16 is arranged to be pressed on the photoreceptor 11 with the intermediate transfer belt 15 interposed therebetween, and is configured such that a voltage (primary transfer bias) with an opposite polarity to a charging polarity (minus polarity and the same applies below) of the toner is applied to the primary transfer roll 16. As a result, the toner image on each photoreceptor 11 is sequentially electrostatically sucked onto the intermediate transfer belt 15, which leads to the formation of overlapped toner images on the intermediate transfer belt 15.

The secondary transfer portion 20 comprises the back roll 25 and a secondary transfer roll 22 that is arranged on a toner image-holding surface side of the intermediate transfer belt 15.

The back roll 25 is formed such that the surface resistivity thereof is 1×10⁷Ω/□ or more and 1×10¹⁰Ω/□ or less. The hardness of the back roll 25 is set to, for example, 700 (ASKER C: manufactured by KOBUNSHI KEIKI CO., LTD., the same shall apply hereinafter). The back roll 25 is arranged on the back surface side of the intermediate transfer belt 15 to configure a counter electrode of the secondary transfer roll 22. A power supply roll 26 made of a metal to which secondary transfer bias is stably applied is arranged to come into contact with the back roll 25.

On the other hand, the secondary transfer roll 22 is a cylindrical roll having a volume resistivity of 10^{7.5} Ω·cm or more and 10^{8.5} Ω·cm or less. The secondary transfer roll 22 is arranged to be pressed on the back roll 25 across the intermediate transfer belt 15. The secondary transfer roll 22 is grounded such that the secondary transfer bias is formed between the secondary transfer roll 22 and the back roll 25, which induces secondary transfer of the toner image onto the paper K transported to the secondary transfer portion 20.

On the downstream side of the secondary transfer portion 20 of the intermediate transfer belt 15, the secondary transfer belt-cleaning blade 35 separable from the intermediate transfer belt 15 is provided which removes the residual toner or paper powder on the intermediate transfer belt 15 remaining after the secondary transfer and cleans the outer peripheral surface of the intermediate transfer belt 15.

On the downstream side of the secondary transfer portion 20 of the secondary transfer roll 22, a secondary transfer roll-cleaning member 22A is provided which removes the residual toner or paper powder on the secondary transfer roll 22 remaining after the secondary transfer and cleans the outer peripheral surface of the intermediate transfer belt 15. Examples of the secondary transfer roll-cleaning member 22A include a cleaning blade. The secondary transfer roll-cleaning member 22A may be a cleaning roll.

The image forming apparatus 100 may have a configuration in which the apparatus includes a secondary transfer belt (an example of a secondary transfer member) instead of the secondary transfer roll 22.

On the other hand, on the upstream side of the yellow image forming unit 1Y, a reference sensor (home position sensor) 42 is arranged which generates a reference signal to be a reference for taking the image forming timing in each of the image forming units 1Y, 1M, 1C, and 1K. On the downstream side of the black image forming unit 1K, an image density sensor 43 for adjusting image quality is arranged. The reference sensor 42 recognizes a mark provided on the back side of the intermediate transfer belt 15 and generates a reference signal. Each of the image forming units 1Y, 1M, 1C, and 1K is configured such that these units start to form images according to the instruction from the control unit 40 based on the recognition of the reference signal.

The image forming apparatus according to the present exemplary embodiment includes, as a transport unit for transporting the paper K, a paper storage portion 50 that stores the paper K, a paper feeding roll 51 that takes out and transports the paper K stacked in the paper storage portion 50 at a predetermined timing, a transport roll 52 that transports the paper K transported by the paper feeding roll 51, a transport guide 53 that sends the paper K transported by the transport roll 52 to the secondary transfer portion 20, a transport belt 55 that transports the paper K transported after going through secondary transfer by the secondary transfer roll 22 to the fixing device 60, and a fixing entrance guide 56 that guides the paper K to the fixing device 60.

Next, the basic image forming process of the image forming apparatus according to the present exemplary embodiment will be described.

In the image forming apparatus according to the present exemplary embodiment, image data output from an image reading device not shown in the drawing, a personal computer (PC) not shown in the drawing, or the like is subjected to image processing by an image processing device not shown in the drawing, and then the image forming units 1Y, 1M, 1C, and 1K perform the image forming operation.

In the image processing device, image processing, such as shading correction, misregistration correction, brightness/color space conversion, gamma correction, or various image editing works such as frame erasing or color editing and movement editing, is performed on the input image data. The image data that has undergone the image processing is converted into color material gradation data of 4 colors, Y, M, C, and K, and is output to the laser exposure machine 13.

In the laser exposure machine 13, according to the input color material gradation data, for example, the photoreceptor 11 of each of the image forming units 1Y, 1M, 1C, and 1K is irradiated with the exposure beam Bm emitted from a semiconductor laser. The surface of each of the photoreceptors 11 of the image forming units 1Y, 1M, 1C, and 1K is charged by the charger 12 and then scanned and exposed by the laser exposure machine 13. In this way, an electrostatic latent image is formed. By each of the image forming units 1Y, 1M, 1C, and 1K, the formed electrostatic latent image is developed as a toner image of each of the colors Y, M, C, and K.

In the primary transfer portion 10 where each photoreceptor 11 and the intermediate transfer belt 15 come into contact with each other, the toner images formed on the photoreceptors 11 of the image forming units 1Y, 1M, 1C, and 1K are transferred onto the intermediate transfer belt 15. More specifically, in the primary transfer portion 10, by the primary transfer roll 16, a voltage (primary transfer bias) with a polarity opposite to the polarity of the charging polarity (negative polarity) of the toner is applied to the base material of the intermediate transfer belt 15, and the toner images are sequentially overlapped on the outer peripheral surface of the intermediate transfer belt 15 and subjected to primary transfer.

After the primary transfer by which the toner images are sequentially transferred to the outer peripheral surface of the intermediate transfer belt 15, the intermediate transfer belt 15 moves, and the toner images are transported to the secondary transfer portion 20. In a case where the toner images are transported to the secondary transfer portion 20, in the transport unit, the paper feeding roll 51 rotates in accordance with the timing at which the toner images are transported to the secondary transfer portion 20, and the paper K having the target size is fed from the paper storage portion 50. The paper K fed from the paper feeding roll 51 is transported by the transport roll 52, passes through the transport guide 53, and reaches the secondary transfer portion 20. Before reaching the secondary transfer portion 20, the paper K is temporarily stopped, and a positioning roll (not shown in the drawing) rotates according to the movement timing of the intermediate transfer belt 15 holding the toner images, so that the position of the paper K is aligned with the position of the toner images.

In the secondary transfer portion 20, via the intermediate transfer belt 15, the secondary transfer roll 22 is pressed on the back roll 25. At this time, the paper K transported at the right timing is interposed between the intermediate transfer belt 15 and the secondary transfer roll 22. At this time, in a case where a voltage (secondary transfer bias) with the same polarity as the charging polarity (negative polarity) of the toner is applied from the power supply roll 26, a transfer electric field is formed between the secondary transfer roll 22 and the back roll 25. In the secondary transfer portion 20 pressed by the secondary transfer roll 22 and the back roll 25, the unfixed toner images held on the intermediate transfer belt 15 are electrostatically transferred onto the paper K in a batch.

Thereafter, the paper K to which the toner images are electrostatically transferred is transported in a state of being peeled off from the intermediate transfer belt 15 by the secondary transfer roll 22, and is transported to the transport belt 55 provided on the downstream side of the secondary transfer roll 22 in the paper transport direction. The transport belt 55 transports the paper K to the fixing device 60 according to the optimum transport speed in the fixing device 60. The unfixed toner images on the paper K transported to the fixing device 60 are fixed on the paper K by being subjected to a fixing treatment by heat and pressure by the fixing device 60. Then, the paper K on which a fixed image is formed is transported to an ejected paper-storing portion (not shown in the drawing) provided in an output portion of the image forming apparatus.

After the transfer to the paper K is finished, the residual toner remaining on the intermediate transfer belt 15 is transported to the secondary transfer belt-cleaning blade 35 as the intermediate transfer belt 15 rotates, and is removed from the intermediate transfer belt 15 by the secondary transfer belt-cleaning blade 35.

Hitherto, the present exemplary embodiment has been described. However, the present exemplary embodiment is not limited to the above exemplary embodiments, and various modifications, changes, and ameliorations can be added thereto.

### EXAMPLES

Examples of the present invention will be described below, but the present invention is not limited to the following examples. In the following description, all “parts” and “%” are in terms of mass unless otherwise specified.

### Example 1

### Cleaning Blade

Polycaprolactone polyol (manufactured by Daicel Corporation, PRAXEL 205, average molecular weight of 529, hydroxyl value of 212 KOHmg/g) and polycaprolactone polyol (manufactured by Daicel Corporation, PRAXEL 240, average molecular weight of 4155, hydroxyl value of 27 KOHmg/g) are used as a soft segment material for the polyol component. Furthermore, an acrylic resin containing two or more hydroxyl groups (Soken Chemical & Engineering Co., Ltd., ACTFLOW UMB-2005B) is used as a hard segment material. The aforementioned soft segment material and the hard segment material are mixed together at a ratio of 8:2 (mass ratio).

Then, as an isocyanate compound, 6.26 parts of 4,4′-diphenylmethane diisocyanate (manufactured by Nippon Polyurethane Industry Co., Ltd., MILLIONATE MT) is added to 100 parts of the mixture of the soft segment material and the hard segment material, and the obtained mixture is reacted at 70° C. for 3 hours in a nitrogen atmosphere. The amount of the isocyanate compound used in this reaction is selected such that the ratio of the isocyanate group to the hydroxyl group contained in the reaction system (isocyanate group/hydroxyl group) is 0.5.

Subsequently, 34.3 parts of the isocyanate compound is further added thereto, and the obtained mixture is reacted at 70° C. for 3 hours in a nitrogen atmosphere, thereby obtaining a prepolymer. The total amount of the isocyanate compound used in using the prepolymer is 40.56 parts.

Thereafter, the prepolymer is heated to 100° C. and defoamed under reduced pressure for 1 hour. Thereafter, 7.14 parts of a mixture of 1,4-butanediol and trimethylolpropane (mass ratio=60/40) is added to 100 parts of the prepolymer, and the mixture is mixed for 3 minutes such that bubbles are not generated, thereby preparing a composition A for forming a blade.

Next, the composition A for forming a blade is poured into a centrifugal molding machine having a mold adjusted to 140° C. and allowed to undergo a curing reaction for 1 hour. Next, the resultant is aged and heated at 110° C. for 24 hours, cooled, and cut, thereby obtaining a blade member having a length of 360 mm, a width of 12 mm, and a thickness of 2 mm.

A filter-cathode vacuum arc (FCVA) method is applied to the obtained blade member, such that a vacuum arc discharge of graphite is performed to generate carbon plasma and ionized carbon is extracted and deposited from the carbon plasma. The tetrahedral amorphous coating is performed by using the FCVA apparatus manufactured by SHIMADZU CORPORATION to obtain a blade member having a tetrahedral amorphous carbon (Tac)-treated layer.

As the forming conditions, the film forming temperature is 40° C. or higher and 80° C. or lower, and the film forming rate is 1.5 nm/s.

The obtained blade member having a Tac-treated layer is adhered to a support material (SUS) to obtain a cleaning blade.

The Young's modulus of the contact portion of the cleaning blade is 10 MPa.

### Secondary Transfer Roll

A secondary transfer roll having a diameter Φ of 28 mm and a length of 350 mm coated with a fluorine particles-containing urethane resin on a urethane elastic foam roll is prepared.

### Image Forming Apparatus

The secondary transfer roll and the cleaning blade as a cleaning blade for cleaning the secondary transfer roll are mounted to the secondary transfer unit of the image forming apparatus “ApeosPort VII C6688 manufactured by Fujifilm Business Innovation Corp.”

The cleaning blade is attached to the apparatus such that a protrusion length from the secondary transfer roll is 5 mm, a total load is 525 gf (line contact pressure of 1.5 gf/mm) with respect to the secondary transfer roll, and a contact angle with the secondary transfer roll is 50°.

The above image forming apparatus is used as the image forming apparatus of Example 1.

### Examples 2 to 20 and Comparative Examples 1 and 2

The same apparatus as in Example 1 is used as an image forming apparatus in Examples 2 to 20 and Comparative Examples 1 and 2, except that the protrusion length from the secondary transfer roll, the line contact pressure with respect to the secondary transfer roll, and the contact angle with the secondary transfer roll are changed according to Table 1.

In addition, an apparatus using the cleaning blade in which the composition of the cleaning blade is changed and the Young's modulus of the contact portion shown in Table 1 is adopted is used as an image forming apparatus of Examples 1 to 20 and Comparative Examples 1 and 2.

### Evaluation

The following evaluation is performed using the image forming apparatus in each example.

### Presence or Absence of Occurrence of Curling of Cleaning Blade

After the image forming apparatus of each example is left to stand in an environment of 28° C. and 85% RH for 24 hours, 10 sheets×2000 of A4 blank paper are loaded into the apparatus, and whether or not blade curling occurs while forming a total of 200,000 images is evaluated according to the following criteria.

### Evaluation Criteria for Blade Curling

S: Curling is not occurred.
A: Curling occurs in 100,000 or more and 200,000 or less sheets.
B: Curling occurs in 10,000 or more and less than 100,000 sheets.
C: Curling occurs in less than 10,000 sheets.

### Initial Cleaning Property: Evaluation of Back Surface Contamination

After the image forming apparatus of each example is left to stand in an environment of 10° C. and 15% RH for 24 hours, a solid image having a density of 100% (25% for each color of YMCK) is directly transferred to a secondary transfer roll, and then the A3 paper is run. The presence or absence of the back surface contamination is evaluated according to the following criteria.

Cleaning Property after Image Formation: Evaluation of Back Surface Contamination

After completion of the evaluation of the occurrence of curling of the cleaning blade, the cleaning properties after image formation is evaluated according to the following criteria in the same manner as the evaluation of the initial cleaning properties.

### Evaluation Criteria for Cleaning Properties

S: Contamination is not generated.
A: Back surface contamination is generated very slightly (almost no problem).
B: Minor back surface contamination is generated (acceptable)
C: Cannot be evaluated since unacceptable back surface contamination is generated or unacceptable blade curling is occurred.

TABLE 1

| | | | | Installation condition of cleaning | | | | | |
|---|---|---|---|---|---|---|---|---|---|
| | | | Secondary | blade | | | Evaluation | | |
| | Cleaning blade | | transfer | | Line | | | | Back surface |
| | Young's | Blade | roll | Protrusion | contact | | | Initial back | contamination |
| | modulus | length | Length | length | pressure | Contact | Blade | surface | after image |
| | (MPa) | (mm) | (mm) | (mm) | (gf/mm) | angle (°) | curling | contamination | formation |
| Example 1 | 10 | 360 | 350 | 5 | 1.5 | 50 | S | B | B |
| Example 2 | 10 | 360 | 350 | 5 | 4.0 | 18 | S | A | B |
| Example 3 | 10 | 360 | 350 | 5 | 1.7 | 40 | S | S | S |
| Example 4 | 10 | 360 | 350 | 5 | 3.0 | 20 | S | S | S |
| Example 5 | 10 | 350.1 | 350 | 0.05 | 1.5 | 18 | B | B | B |
| Example 6 | 10 | 350.2 | 350 | 0.1 | 1.5 | 18 | A | A | A |
| Example 7 | 10 | 352 | 350 | 1 | 1.7 | 20 | S | S | S |
| Example 8 | 10 | 351 | 350 | 0.5 | 1.7 | 20 | A | S | S |
| Example 9 | 4 | 360 | 350 | 5 | 1.7 | 18 | B | B | B |
| Example 10 | 5 | 360 | 350 | 5 | 1.7 | 18 | A | B | B |
| Example 11 | 30 | 360 | 350 | 5 | 1.7 | 20 | S | S | A |
| Example 12 | 32 | 360 | 350 | 5 | 1.7 | 20 | S | S | B |
| Example 13 | 10 | 360 | 350 | 5 | 1.3 | 18 | S | B | B |
| Example 14 | 10 | 360 | 350 | 5 | 1.5 | 18 | S | A | A |
| Example 15 | 10 | 360 | 350 | 5 | 3 | 18 | A | S | A |
| Example 16 | 10 | 360 | 350 | 5 | 4.5 | 18 | B | S | B |
| Example 17 | 10 | 360 | 350 | 5 | 1.7 | 15 | S | A | B |
| Example 18 | 10 | 360 | 350 | 5 | 1.7 | 18 | S | S | A |
| Example 19 | 10 | 360 | 350 | 5 | 1.7 | 50 | A | S | A |
| Example 20 | 10 | 360 | 350 | 5 | 1.7 | 55 | B | A | B |
| Comparative | 10 | 340 | 350 | −5 | 4.5 | 55 | C | S | C |
| Example 1 | | | | | | | | | |
| Comparative | 10 | 340 | 350 | −5 | 1.0 | 15 | B | C | C |
| Example 2 | | | | | | | | | |

As shown in the results described above, it may be seen that the curling of the cleaning blade is suppressed in the present examples as compared with the comparative examples.

In particular, in Examples 3, 4, and 7, it may be seen that curling of the cleaning blade is suppressed while ensuring good cleaning properties.

Comparative Example 2 is an example in which the cleaning blade is installed such that the line contact pressure and the contact angle are excessively low, and is an example in which the back surface contamination of the paper is generated and the cleaning function is not exhibited.

The present exemplary embodiment includes the following aspects.

(((1)))

An image forming apparatus comprising:
a member to be cleaned; and
a cleaning blade that is brought into contact with the member to be cleaned and cleans the member to be cleaned and that is provided with both end portions in a longitudinal direction protruding from the member to be cleaned.
   (((2)))

The image forming apparatus according to (((1))),
wherein the protrusion length from the member to be cleaned at an end portion in the longitudinal direction of the cleaning blade is 0.1 mm or more.
   (((3)))

The image forming apparatus according to (((2))),
wherein the protrusion length from the member to be cleaned at the end portion in the longitudinal direction of the cleaning blade is 1.0 mm or more.
   (((4)))

The image forming apparatus according to any one of (((1))) to (((3))),
wherein a line contact pressure of the cleaning blade to the member to be cleaned is 1.5 gf/mm or more and 4.0 gf/mm or less.
   (((5)))

The image forming apparatus according to any one of (((1))) to (((4))),
wherein a contact angle of the cleaning blade to the member to be cleaned is 180 or more and 50° or less.
   (((6)))

The image forming apparatus according to any one of (((1))) to (((5))),
wherein a Young's modulus of a contact portion of the cleaning blade that is brought into contact with the member to be cleaned is 5 MPa or more and 30 MPa or less.
   (((7)))

A process cartridge comprising:
a member to be cleaned; and
a cleaning blade that is brought into contact with the member to be cleaned and cleans the member to be cleaned and that is provided with both end portions in a longitudinal direction protruding from the member to be cleaned,
wherein the process cartridge is detachably attached to an image forming apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a member to be cleaned; and
a cleaning blade that is brought into contact with the member to be cleaned and cleans the member to be cleaned and that is provided with both end portions in a longitudinal direction protruding from the member to be cleaned.

2. The image forming apparatus according to claim 1,
wherein a protrusion length from the member to be cleaned at an end portion in the longitudinal direction of the cleaning blade is 0.1 mm or more.

3. The image forming apparatus according to claim 2,
wherein the protrusion length from the member to be cleaned at the end portion in the longitudinal direction of the cleaning blade is 1.0 mm or more.

4. The image forming apparatus according to claim 1,
wherein a line contact pressure of the cleaning blade to the member to be cleaned is 1.5 gf/mm or more and 4.0 gf/mm or less.

5. The image forming apparatus according to claim 1,
wherein a contact angle of the cleaning blade to the member to be cleaned is 180 or more and 50° or less.

6. The image forming apparatus according to claim 1,
wherein a Young's modulus of a contact portion of the cleaning blade that is brought into contact with the member to be cleaned is 5 MPa or more and 30 MPa or less.

7. A process cartridge comprising:
a member to be cleaned; and
a cleaning blade that is brought into contact with the member to be cleaned and cleans the member to be cleaned and that is provided with both end portions in a longitudinal direction protruding from the member to be cleaned,
wherein the process cartridge is detachably attached to an image forming apparatus.
